(19) United States
(12) Patent Application Publication
(10) Pub. No.: US 2011/0161978 A1
(43) Pub. Date: Jun. 30, 2011

(54) JOB ALLOCATION METHOD AND APPARATUS FOR A MULTI-CORE SYSTEM

(75) Inventors: Oh-Young Jang, Suwon-si (KR); Hyo-Jung Song, Seoul (KR); Seung-Mo Cho, Seoul (KR); Seung-Hak Lee, Yongin-si (KR); Dong-Woo Im, Yongin-si (KR); Sung-Jong Seo, Hwaseong-si (KR)

(73) Assignee: SAMSUNG ELECTRONICS CO., LTD., Suwon-si (KR)

(21) Appl. No.: 12/842,470

(22) Filed: Jul. 23, 2010

(30) Foreign Application Priority Data
Dec. 28, 2009 (KR) 10-2009-0131711

(51) Int. Cl. G06F 9/50

(52) U.S. Cl. 718/104; 718/105

(57) ABSTRACT

A method and apparatus for efficiently allocating jobs to processing cores included in a computing system, are provided. The multi-core system includes a plurality of cores that may collect performance information of each respective core while the cores are executing a requested task in parallel. The multi-core system allocates additional jobs of the requested task to the cores based on the performance information and the amount of jobs remaining.

### CROSS-REFERENCE TO RELATED APPLICATION(S)

This application claims the benefit under 35 U.S.C. §119(a) of Korean Patent Application No. 10-2009-0131711, filed on Dec. 28, 2009, the entire disclosure of which is incorporated herein by reference for all purposes.

### BACKGROUND

1. Field

The following description relates to a multi-core system, and more particularly, to a method and apparatus for efficiently allocating jobs to a plurality of cores included in a computing system.

2. Description of the Related Art

With the increase in demand for low-power, high-performance, electronic devices, such as cell phones, digital cameras, personal computers, and the like, the need for multi-core processing has increased. Examples of a multi-core system include a symmetric multi-processing (SMP) system and an asymmetric multi-processing (AMP) system that consists of various different types of cores such as a digital processing processor (DSP) and a graphic processing unit (GPU). The various cores may be used as a general purpose processor (GPP).

To improve performance of software that processes a large amount of data, the software may be processed in a parallel manner on multiple cores, simultaneously. In this example, the total amount of data to be processed is divided into segments of data and each segment of data is allocated to a specified core for data processing. To segment the data, a static scheduling method may be used by which the total amount of data to be processed is divided based on the number of cores and jobs corresponding to the divided data are allocated to the cores.

In some embodiments, a dynamic scheduling method may be used by which a core that has completed the processing of an allocated job then takes over processing a part of a job allocated to another core and processes the job to improve the overall performance of the cores. The dynamic scheduling method may be used to compensate for delayed processing that occurs when the job completion timing of the respective cores are different from one another due to various influences. The job completion timing may be affected by, for example, an operating system, a multi-core software platform, other application programs, and the like, even when the data to be processed has been divided into equally sized data segments. The methods described above often use work queues for the respective cores. The total amount of data is divided into a number of data segments and each data segment is allocated to a work queue of a specified core at the beginning of data processing.

The static scheduling method may achieve optimal performance when cores each have is the same performance and the jobs executed on the cores are not context-switched for other processing. The dynamic scheduling method may only be used when a core can cancel and take over a job allocated to the work queue of another core. Additionally, because a heterogeneous multi-core platform includes cores that have different performances and computing capabilities, it is difficult to estimate the execution time of each core according to a program to be run. Thus, the static scheduling method cannot be effectively applied to a heterogeneous multi-core platform. Furthermore, because a work queue of each core generally resides in a memory region which only the corresponding core can access, it is not possible for one core to access the work queue of another core that is currently operating so as to take a job from the work queue. Because of these drawbacks, it is difficult to employ the dynamic scheduling method or he static scheduling method in a multi-core system.

### SUMMARY

In one general aspect, there is provided a job allocation method for a computing system configured to divide a task into a plurality of jobs and comprising a plurality of cores each processing allocated jobs, the method comprising: collecting performance information for each core of the plurality of cores; and additionally allocating jobs to a core that has the smallest amount of remaining jobs with respect to performance of the core.

The method may further include that the additional allocating of the jobs comprises allocating the jobs to the core which has the smallest amount of remaining jobs with respect to the performance of the core as long as the amount of remaining jobs in the core does not exceed the amount of remaining jobs of another core which has the largest amount of remaining jobs with respect to performance.

The method may further include allocating the same amount of jobs to each core before additionally allocating the jobs.

The method may further include that the collecting of the information comprises is collecting performance information of each core each time a job is completed in each core.

The method may further include that the performance information comprises an arithmetic mean of job processing speeds of the cores.

The method may further include that the computing system is a multi-core system that comprises two or more cores that have different performances.

In another general aspect, there is provided a computing system comprising a plurality of cores, the computing system comprising: a plurality of job processors, each comprising a core and a work queue, the core configured to process one or more jobs with respect to a task requested by a predetermined application, the work queue configured to store performance information of the processed jobs; and a host processor configured to allocate the jobs to the job processors based on the amount of remaining jobs, with respect to performance, of each job processor.

The computing system may further include that the host processor comprises: a work queue monitor configured to periodically monitor a status of the work queue of each job processor; and a work scheduler configured to: divide the task requested by the predetermined application into the plurality of jobs; and allocate the jobs to the job processors.

The computing system may further include that the performance information of each job processor comprises an arithmetic mean of job processing speeds of the cores.

The computing system may further include that the cores comprise different performances.

In another general aspect, there is provided a host processor, configured to: receive a request from an application to perform a task; divide the requested task into a plurality of jobs; initially allocate a portion of the plurality of jobs to a plurality of processing cores to process the portion of the plurality of jobs in parallel; collect performance information for each core of the is plurality of cores based on the each respective core's processing of the initially allocated jobs; and additionally allocate remaining jobs of the requested task to one or more of the processing cores based on the collected performance information of each core and the amount of jobs remaining.

The host processor may further include that: the performance information is received from each core of the plurality of cores; and the performance information comprises at least one of: job processing speed, an amount of data that has been processed by a respective core, an amount of jobs processed by a respective core, an amount of data that remains to be processed by a respective core, and an amount of jobs remaining to be processed by a respective core.

The host processor may further include that: the host processor is further configured to calculate the number of jobs remaining to be processed; and the host processor is further configured to determine an expected performance ratio of the plurality of processors based on the calculated number of jobs remaining.

The host processor may further include that the host processor is further configured to determine the actual performance ratio of each processor based on the collected performance information.

The host processor may further include that the host processor is further configured to allocate the remaining jobs based on the expected performance ratio and the actual performance ratio, such that the actual performance ratio is increased and is closer in value to the expected performance ratio based upon allocation of the remaining jobs.

Other features and aspects may be apparent from the following description, the drawings, and the claims.

### BRIEF DESCRIPTION OF THE DRAWINGS

FIG. 1 is a diagram illustrating an example of a multi-core system.

FIG. 2 is a flowchart illustrating an example of allocating jobs to cores in a multi-core system.

FIG. 3A is a diagram illustrating an example of a multi-core system in which jobs are allocated to cores

FIG. 3B is a diagram illustrating an example of a multi-core system in which jobs are allocated to cores.

Throughout the drawings and the description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

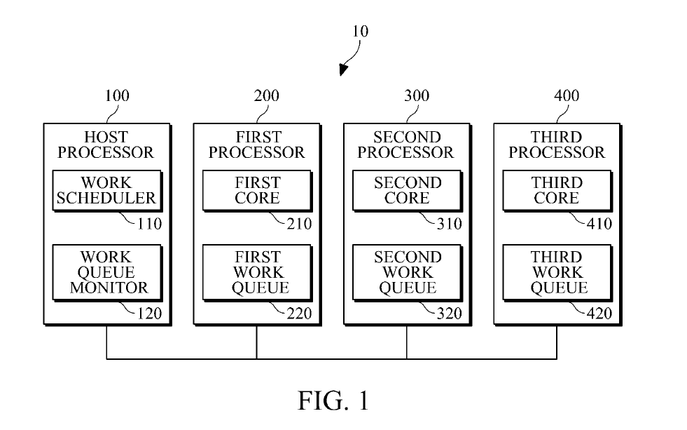

FIG. 1 illustrates an example of a multi-core system.

Referring to the example shown in FIG. 1, the multi-core system 10 may include four processors 100, 200, 300, and 400. The four processors may include a host processor 100, a first job processor 200, a second job processor 300, and a third job processor 400. The host is processor 100 may receive a request for executing a task from an application, and may divide the task into a plurality of jobs to be executed by the first, second, and third job processors 200, 300, and 400. The host processor 100 may control and manage the job allocation to the respective job processors 200, 300, and 400 and the job execution in the job processors 200, 300, and 400. The first, the second, and the third job processors 200, 300, and 400 may directly execute the allocated jobs.

The example of a host processor and three job processors shown in FIG. 1 is merely for purposes of example. It should be understood that one or more host processors may be included and a plurality of job processors may be in included in the multi-core system. For example, the multi-core system may include two job processors, three job processors, four job processors, or more job processors.

Job processors 200, 300, and 400 may include a first core 210, a first work queue 220, a second core 310, a second work queue 320, a third core 410, and a third work queue 420, respectively. Although the multi-core system shown in the example of FIG. 1 is an asymmetric multi-core system in which the cores 210, 310, and 410 of the respective job processors 200, 300, and 400 are different from one another, the multi-core system is not limited thereto. Accordingly, two or more of the cores may be of the same type and construction.

The first, the second, and the third work queues 220, 320, and 420 may store information of jobs to be processed by the first, second, and third cores 210, 310, and 410, respectively. The first, the second, and the third cores 210, 310, and 410 may read in data from a primary storage unit such as dynamic random access memory (DRAM) or other storage unit such as hard disk drive, and may perform operations based on the information stored in the respective first, second, and third work queues 220, 320, and 420.

As described herein, the cores 210, 310, and 410 may be, for example, a central processing unit (CPU), a digital processing processor (DSP), a graphic processing unit (GPU), is and the like. The first, the second, and the third cores 210, 310, and 410 may be the same as one another or different from one another. For example, the first core 210 may be a DSP, and the second core 310 and the third core 410 may be GPUs.

The first, the second, and the third work queues 220, 320, and 420 may reside in local memories of the processors 200, 300, and 400, respectively. In addition, the local memories of the processors 200, 300, and 400 may include the first core 210, the second core 310, and the third core 410, as shown in the example illustrated in FIG. 1.

The host processor 100 may divide a specific task requested by a predetermined application into a plurality of jobs that are to be processed by a plurality of processors. The host processor 100 may allocate the jobs to the processors and manage the overall processing. Accordingly, the host processor 100 may include a work scheduler 110 and a work queue monitor 120.

The work queue monitor 120 of the host processor 100 may periodically monitor the status of each work queue 220, 320, and 420 in each of the job processors 200, 300, and 400 of the multi-core system 10, to monitor the overall performance of each individual job processor 200, 300, and 400. The monitoring interval of the work queue monitor 120 may vary according to the specifications for the performance of the multi-core system 10. For example, each core 210, 310, and 410 may monitor the status of the corresponding work queue 220, 320, and 420 at predetermined time intervals, or each core 210, 310, and 410 may monitor the corresponding work queue each time a corresponding job is completed in the core 210, 310, and 410. Accordingly, the work queue monitor 120 may receive a notification from the respective cores 210, 310, and 410 to inform the work queue monitor 120 that the processing of a job has been completed.

After dividing the requested task into a plurality of jobs of smaller size, the work is scheduler 110 of the host processor 100 may allocate the divided jobs to the respective job processors 200, 300, and 400. Accordingly, the job processors 200, 300, and 400 may process the jobs in parallel. The work scheduler 110 may determine which processor will process which job and how many jobs based on the status of each work queue that is monitored by the work queue monitor 120.

The work queue monitor 120 may calculate a performance ratio between the cores 210, 310, and 410 of the multi-core system 10 while updating a number of jobs that have been processed in a predetermined period of time by the respective cores 210, 310, and 410. In addition, the work queue monitor 120 may monitor the job processing speed of each core based on the amount of data that has been processed by the core within the predetermined time period. In response to the calculation of the performance ratio between the cores 210, 310, and 410, the work scheduler 110 may calculate a ratio of the numbers of jobs remaining in the respective work queues 220, 320, and 420 or a ratio of the amounts of calculation data to be processed by the jobs remaining in the respective work queues 220, 320, and 420, and compare the calculated ratio with the performance ratio between the cores. Based on these calculations, the work scheduler 110 may determine which core an additional job should be allocated to so as to make the calculated ratio and the performance ratio of the cores as similar as possible. In addition, the work scheduler 120 may allocate the job to the determined work queue of the identified core.

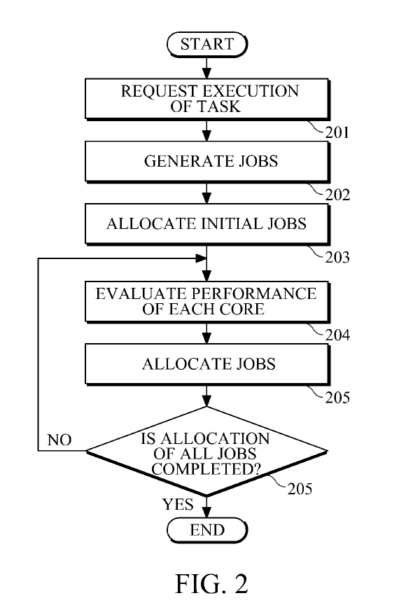

FIG. 2 illustrates an example of allocating jobs to cores in a multi-core system.

Referring to FIG. 2, the multi-core system may receive a task execution request from a particular application in operation 201. One or more applications may be running on the computing system, and the computing system includes a multi-core system such as the multi-core system as shown in the example illustrated in FIG. 1. The application may request tasks to be performed in a specific order. The tasks may include the generation of new data or transformation of existing data into a different form. The task may be executed by the multi-core system that processes data read from a primary storage device such as a DRAM or other storage unit such as hard disk drive, and the like.

In response to the task execution request, in operation 202 the multi-core system may divide the requested task into a plurality of jobs. The jobs may be of smaller size than the requested task so that the processors included in the multi-core system may process the task in parallel. However, the jobs are not necessarily equal in size, that is, the jobs may be the same in size or may be different in size. The size of the jobs may be determined based on characteristics of the task to be processed, the number of processors included in the multi-core system, the performance of each processor, the configuration of the whole computing system, and the like.

After the generation of the jobs, in operation 203 the multi-core system may allocate initial jobs to the processors included in the multi-core system. The initial jobs may include one or more jobs that are allocated to each of the processors. The number of initial jobs may be determined based on characteristics of the task to be processed, the number of processors included in the multi-core system, the performance of each processor in the system, the configuration of the whole computing system, and the like.

The allocation of the multi-core system may be performed by enqueuing information of each job into a work queue that is disposed inside each processor.

Thereafter, in operation 204 the multi-core system may monitor the performance of a core equipped in each processor. The monitoring may be performed by periodically checking a status of the work queue of each processor included in the multi-core system, the total amount of work processed by each processor within a predetermined time period, the overall performance of each processor, and the like.

The monitoring period for the work queue may vary according to the specifications and is the performance of the multi-core system. For example, each core may monitor the status of the corresponding work queue at predetermined time intervals, or each core may monitor the status of the corresponding work queue each time a corresponding job is completed in the core. Accordingly, the respective processors may send notifications to the host processor to inform the host processor of the completion of a corresponding job. The notification may include information about the total time spent executing a job including the job execution starting and termination times.

For example, the performance of each core may be evaluated by obtaining the arithmetic mean of the job processing speed. The arithmetic mean of the job processing speed may be calculated by calculating the number of jobs that have been processed by each core or the amount of data of the jobs that have been processed and dividing this number by the time elapsed for executing the jobs. In this example, although each core may process the allocated jobs with the same performance initially, the performance of a core tends to improve over time due to code transmission time and code cache. Accordingly, instead of calculating the entire number of jobs executed by a processor, only the number of jobs that have been recently executed may be calculated and used for the performance evaluation. Based on such information, the performance of each core may be calculated while the number of jobs and the amount of data that each core processes within a predetermined time period may be updated.

In another example, an initial value of the performance of each core may be set to a smallest number that is not zero. This may be done to prevent the evaluated performance value of each core from being infinite even when only some of the cores issue a notification that the job at the initial stage has been completed.

Additional jobs may be allocated to the processors in operation 205. The additional jobs may be allocated based on a comprehensive consideration of the performance of the core inside each processor and the amount of remaining jobs that are queued in the work queue of the each processor, which may be identified at operation 204.

For example, a core and the number of jobs to be allocated to the core may be determined to set remaining-job-to-performance ratios of the respective cores to be the same as one another. In other words, the remaining-job-to-performance ratios may be set to minimize the deviation between the means of the remaining jobs and the evaluated performance values. Accordingly, after the evaluated performance values of the respective cores are obtained, the ratio of the numbers of jobs remaining in the work queues of the respective cores or the ratio of the amounts of data to be processed by the jobs remaining in the work queues of the respective cores may be calculated, and the calculated ratio may be compared with the performance ratio between the cores.

Then, it may be determined how many jobs should be individually allocated to each core to make the evaluated ratio of the amounts of jobs in the respective cores as similar as possible to the performance ratio between those cores. Thereafter, additional jobs may be enqueued into a work queue of the core that makes the two ratios the most similar to each other. When the remaining-job-to-performance ratio of a core is small, it may indicate that the corresponding core has a smaller number of jobs than its performance ratio dictates it should.

By repeating the operations 204 and 205, job allocation with respect to the task requested by the application may be completed in operation 206, the procedure may be terminated, and the next instruction may be awaited.

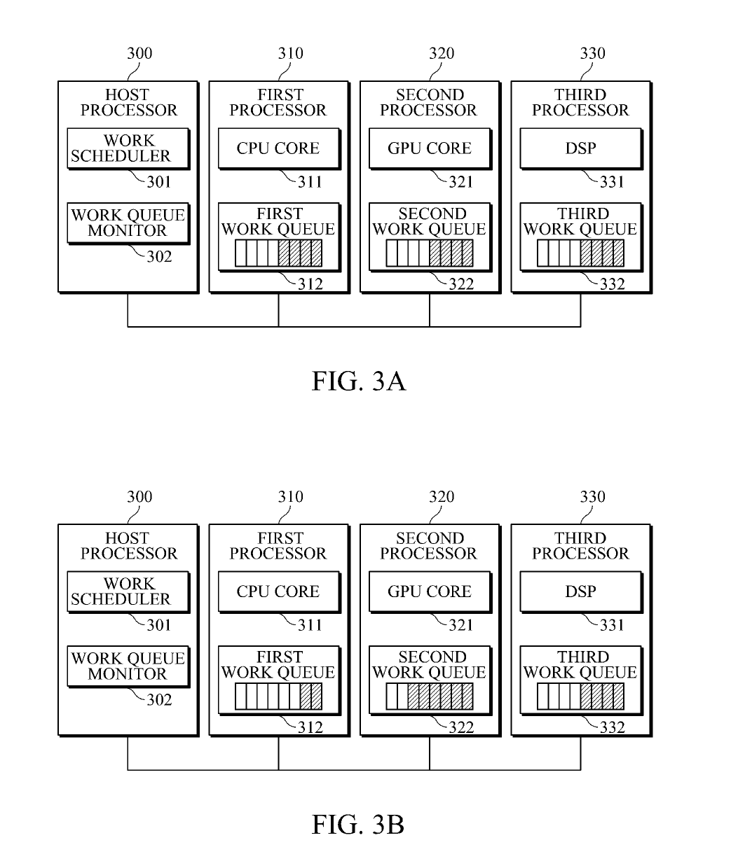

FIGS. 3A and 3B illustrate examples of a multi-core system in which jobs are allocated to cores.

The multi-core system shown in the examples illustrated in FIGS. 3A and 3B may include three job processors 310, 320, and 330, and one host processor 300. The job processors may include a first processor 310 that may include a CPU core 311, a second processor 320 that is may include a GPU core 321, and a third processor 330 that may include a DSP 331.

In the example illustrated in FIG. 3A, a task requested by an application may be divided by a work scheduler 301 of the host processor 300 into thirty jobs. Subsequently, each core 311, 321, and 331 may be allocated four initial jobs. Accordingly, eighteen jobs may be remaining in the work scheduler 301.

In response to the input of the initial jobs to work queues 312, 322, and 332 of the respective job processors 310, 320, and 330, the corresponding cores 311, 321, and 331 may start processing the allocated initial jobs. Each time a core completes a job, the core may issue a notification to a work queue monitor 302 to inform the work queue monitor 302 that a job has been completed. The notification may include, for example, the total time spent for executing the corresponding job, the job starting and termination times, and the like.

The work queue monitor 302 may calculate a performance ratio between the cores 311, 321, and 331 of the multi-core system and may update the number of jobs that have been processed by the respective cores 311, 321, 331 within a predetermined period of time and/or the job processing speed of each core that includes the amount of data that has been processed by each core within the predetermined period of time.

In response to the calculation of the performance ratio between the cores 311, 321, and 331, the work scheduler 301 may calculate a ratio of the numbers of jobs remaining in the respective work queues 312, 322, and 332 and/or a ratio of the amounts of calculation data to be processed by the jobs remaining in the respective work queues 312, 322, and 332. Then, the work scheduler 301 may compare the calculated ratio with the performance ratio of the cores. Accordingly, the work scheduler 301 may identify which core should be allocated an additional job so as to make the calculated ratio and the performance ratio between the cores more similar to each other, and may allocate a job to the work queue of the identified core.

FIG. 3B illustrates another example of the multi-core system. In the example illustrated is in FIG. 3B, the status of the first, second, and third work queues 312, 322, and 332 of the respective first, second, and third job processors 310, 320, and 330 are shown and the performance ratio between the first core 311, the second core 321, and the third core 331, is approximately 1:3:2. Accordingly, the ratio of the numbers of jobs remaining in the respective work queues 312, 322, and 332 may be arranged to be the same as the performance ratio between the first, second and third cores 311, 321, and 331.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. As a non-exhaustive illustration only, a computing system may refer to a personal computer (PC), a mobile terminal, and the like.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A job allocation method for a computing system configured to divide a task into a plurality of jobs and comprising a plurality of cores each processing allocated jobs, the method comprising:
collecting performance information for each core of the plurality of cores; and
additionally allocating jobs to a core that has the smallest amount of remaining jobs with respect to performance of the core.

2. The method of claim 1, wherein the additional allocating of the jobs comprises allocating the jobs to the core which has the smallest amount of remaining jobs with respect to the performance of the core as long as the amount of remaining jobs in the core does not exceed the amount of remaining jobs of another core which has the largest amount of remaining jobs with respect to performance.

3. The method of claim 1, further comprising allocating the same amount of jobs to each core before additionally allocating the jobs.

4. The method of claim 1, wherein the collecting of the information comprises collecting performance information of each core each time a job is completed in each core.

5. The method of claim 1, wherein the performance information comprises an arithmetic mean of job processing speeds of the cores.

6. The method of claim 1, wherein the computing system is a multi-core system that comprises two or more cores that have different performances.

7. A computing system comprising a plurality of cores, the computing system comprising:
a plurality of job processors, each comprising a core and a work queue, the core configured to process one or more jobs with respect to a task requested by a predetermined application, the work queue configured to store performance information of the processed jobs; and
a host processor configured to allocate the jobs to the job processors based on the amount of remaining jobs, with respect to performance, of each job processor.

8. The computing system of claim 7, wherein the host processor comprises:
a work queue monitor configured to periodically monitor a status of the work queue of each job processor; and
a work scheduler configured to:
divide the task requested by the predetermined application into the plurality of is jobs; and
allocate the jobs to the job processors.

9. The computing system of claim 7, wherein the performance information of each job processor comprises an arithmetic mean of job processing speeds of the cores.

10. The computing system of claim 7, wherein the cores comprise different performances.

11. A host processor, configured to:
receive a request from an application to perform a task;
divide the requested task into a plurality of jobs;
initially allocate a portion of the plurality of jobs to a plurality of processing cores to process the portion of the plurality of jobs in parallel;
collect performance information for each core of the plurality of cores based on the each respective core's processing of the initially allocated jobs; and
additionally allocate remaining jobs of the requested task to one or more of the processing cores based on the collected performance information of each core and the amount of jobs remaining.

12. The host processor of claim 11, wherein:
the performance information is received from each core of the plurality of cores; and
the performance information comprises at least one of: job processing speed, an is amount of data that has been processed by a respective core, an amount of jobs processed by a respective core, an amount of data that remains to be processed by a respective core, and an amount of jobs remaining to be processed by a respective core.

13. The host processor of claim 11, wherein:
the host processor is further configured to calculate the number of jobs remaining to be processed; and
the host processor is further configured to determine an expected performance ratio of the plurality of processors based on the calculated number of jobs remaining.

14. The host processor of claim 13, wherein the host processor is further configured to determine the actual performance ratio of each processor based on the collected performance information.

15. The host processor of claim 14, wherein the host processor is further configured to allocate the remaining jobs based on the expected performance ratio and the actual performance ratio, such that the actual performance ratio is increased and is closer in value to the expected performance ratio based upon allocation of the remaining jobs.
